(19) United States
(12) Patent Application Publication
(10) Pub. No.: US 2003/0104278 A1
(43) Pub. Date: Jun. 5, 2003

(54) Nickel electrode for alkaline storage battery, process for the production thereof, alkaline storage battery comprising same and process for the production thereof

(76) Inventors: Katsuya Ito, Mihara-gun (JP); Takuya Tamagawa, Mihara-gun (JP); Yoichiro Shibata, Tsuna-gun (JP); Chihiro Fujisawa, Sumoto-shi (JP)

Correspondence Address: NIXON & VANDERHYE P.C., 8th Floor, 1100 North Glebe Road, Arlington, VA, 22201-4714, US

(21) Appl. No.: 10/266,704

(22) Filed: Oct. 9, 2002

(30) Foreign Application Priority Data
Nov. 30, 2001 (JP) P. 2001-365993

(51) Int. Cl. H01M 4/52; B05D 5/12; H01M 10/04

(52) U.S. Cl. 429/223; 427/126.6

(57) ABSTRACT

A nickel electrode for alkaline storage battery of the invention comprises an electrically-conductive porous substrate coated with an oxide containing cobalt on the surface thereof and a positive active material coated with nickel and a compound selected from the group consisting of Ca, Sr, Sc, Y, Al, Mn and lanthanoids on the surface thereof. Thus, the coating of the surface of the active material with nickel and a compound containing Ca, Sr, Sc, Y, Al, Mn and lanthanoids causes the enhancement of the effect of increasing oxygen overvoltage at high temperature and hence the charge acceptability. Further, since the gap between the electrically-conductive porous substrate and the positive active material is filled with the oxide containing cobalt, the electrical conductivity thereof can be improved, making it possible to inhibit the deterioration of large current charge properties and large current discharge properties.

### BACKGROUND OF THE INVENTION

The present invention relates to a nickel electrode for alkaline storage battery comprising an electrically-conductive porous substrate filled with a positive active material comprising nickel hydroxide as a main component, a process for the production thereof, an alkaline storage battery comprising such a nickel electrode, and a process for the production thereof.

In recent years, the improvement of alkaline storage batteries such as nickel-cadmium storage battery and nickel-hydrogen storage battery has been under way to meet the demand for high energy density secondary battery. Nickel electrodes for use in this type of alkaline storage batteries include sintered nickel electrode and non-sintered nickel electrode. The sintered nickel electrode is produced by dipping an electrically-conductive porous substrate (e.g., nickel sintered substrate) impregnated with nickel nitrate in an alkaline solution so that nickel nitrate is converted to nickel hydroxide to fill the pores in the electrically-conductive porous substrate with a positive active material comprising nickel hydroxide as a main component. On the other hand, the non-sintered nickel electrode is produced by filling an electrically-conductive porous substrate (e.g., foamed nickel, punching metal) directly with a positive active material comprising nickel hydroxide as a main component in the form of slurry.

In the conventional sintered nickel electrode or non-sintered nickel electrode, the oxygen gas generation potential of the nickel electrode and the charge reaction potential of nickel hydroxide are close to each other. In particular, at high temperature, the oxygen gas generation potential (i.e., oxygen overvoltage) lowers, causing the competition between the oxidation reaction and oxygen gas generation reaction of the nickel active material during charge. As a result, the charge acceptability is deteriorated, raising a problem of deterioration of battery performance at high temperature. Thus, various methods have been proposed for raising the oxygen overvoltage and hence improving the charge acceptability.

For example, Japanese Patent publication JP-A-11-073957 proposes that Ni, Co and Y be incorporated in admixture in a nickel electrode to raise oxygen overvoltage. Further, JP-A-10-125318 proposes that an independent crystal having a group A element such as Mg, Ca and Sr and a group B element such as Co and Mn solid-dissolved therein be provided in the surface layer of a nickel electrode to raise oxygen overvoltage. Moreover, JPA-10-149821 proposes that a surface layer containing Ca, Ti, etc. in a high concentration be formed on a nickel electrode and Al, V, etc. be incorporated in the core of the nickel electrode in a high concentration to raise oxygen overvoltage.

Thus, various methods have been proposed for raising oxygen overvoltage with an element such as Ca, Sr, Y, Al and Mn. In this case, the position of addition of these elements such as Ca, Sr, Y, Al and Mn (site of addition of these elements) is preferably on the surface of nickel hydroxide (Ni(OH)₂) which acts as a main active material so that these elements can be present more in the vicinity of interface with the electrolyte to exert an enhanced effect of raising oxygen overvoltage.

In the case where these elements are present more in the vicinity of interface with the electrolyte, the sintered electrode is preferably produced in the following manner to advantage from the standpoint of availability of existing production facilities. In some detail, an electrically conductive porous substrate is dipped in an acidic salt solution comprising nickel as a main component. Thereafter, the electrically-conductive porous substrate is dipped in an alkaline solution so that it is filled with a hydroxide comprising nickel as a main component. This procedure is repeated predetermined several times to obtain an active material-filled electrode filled with an active material in a predetermined amount. Subsequently, the active material-filled electrode is dipped in a nitrate solution containing an element such as Ca, Sr, Y, Al and Mn. Thereafter, the active material-filled electrode is dipped in an alkaline solution to form a layer of hydroxide of an element such as Ca, Sr, Y, Al and Mn on the surface of the active material-filled electrode.

However, when an element such as Ca, Sr, Y, Al and Mn is provided on the surface of a nickel hydroxide (Ni (OH) 2) active material, such an element such as Ca, Sr, Y, Al and Mn is disadvantageous in that it inhibits the charge-discharge reaction of the nickel hydroxide (Ni (OH)₂) active material. The degree of inhibition of charge-discharge reaction is greater in the case where such an element as Ca, Sr, Y, Al and Mn is provided on the surface of the nickel electrode than in the case where such an element is provided uniformly all over the nickel electrode. Further, since the difference between charge potential and oxygen generation potential during high temperature charge is small, when an element such as Ca, Sr, Y, Al and Mn is provided on the surface of the nickel electrode, the resulting effect of raising oxygen overvoltage is enhanced, inhibiting the generation of oxygen gas and hence improving charge acceptability.

However, since the difference between charge potential and oxygen generation potential during ordinary temperature charge is great, no effect of raising oxygen overvoltage can be exerted even when an element such as Ca, Sr, Y, Al and Mn is provided on the surface of the nickel electrode. On the contrary, the problem of inhibition of charge-discharge reaction on the surface of the nickel electrode due to the element such as Ca, Sr, Y, Al and Mn has an effect on the battery performance. Further, the element such as Ca, Sr, Y, Al and Mn on the surface of the nickel electrode acts as a resistive component to aggravate the effect on large current charge and discharge.

### SUMMARY OF THE INVENTION

Therefore, the invention has been worked out to solve the aforementioned problems. An aim of the invention is to provide a nickel electrode which can inhibit the deterioration of large current charge properties and large current discharge properties even when an element such as Ca, Sr, Y, Al and Mn is provided on the surface of a positive active material and a process for the production thereof.

In order to accomplish the aforementioned aim, the nickel electrode for alkaline storage battery of the invention comprises an electrically-conductive porous substrate coated with an oxide containing at least cobalt on the surface thereof. Further, the nickel electrode for alkaline storage battery of the invention is characterized in that the positive active material comprising nickel hydroxide as a main component is coated with nickel hydroxide and a hydroxide of at least one element selected from the group consisting of Ca, Sr, Sc, Y, Al, Mn and lanthanoids.

Thus, when the surface of the electrically-conductive porous substrate is coated with an oxide containing at least cobalt, the oxide containing cobalt is interposed between the electrically-conductive porous substrate and the positive active material. Further, since the oxide containing cobalt exhibits an excellent electrical conductivity, the electrical conductivity of the gap between the electrically-conductive porous substrate and the positive active material can be improved. It has so far been known that this arrangement makes it possible to relax somewhat the inhibition of charge-discharge reaction due to these elements, thereby inhibiting somewhat the deterioration of large current charge properties and large current discharge properties.

It was found that when the surface of the electrically-conductive porous substrate is coated with an oxide containing at least cobalt and the surface of the positive electrode comprising nickel hydroxide as a main component is coated with nickel hydroxide in addition to the oxide of at least one element selected from the group consisting of Ca, Sr, Sc, Y, Al, Mn and lanthanoids, the inhibition of charge-discharge reaction can be relaxed more than by the aforementioned arrangement.

Thus, the charge acceptability can be improved, and the electrical conductivity of the gap between the electrically-conductive porous substrate and the positive active material can be improved, making it possible to inhibit the deterioration of rapid charge properties and large current discharge properties. In this case, when the oxide containing cobalt is a higher order cobalt oxide (the term “a higher order cobalt oxide” means a cobalt oxide whose valence or oxidation number of cobalt exceeds two), which has a better electrical conductivity, the gap between the electrically-conductive porous substrate and the positive active material can be further improved. As a result, the deterioration of large current charge properties (high rate charge properties) and large discharge properties (high rate discharge properties) can be further inhibited.

In order to accomplish the aforementioned aim, the process for the production of a nickel electrode for alkaline storage battery of the invention comprises a cobalt coating step of coating the surface of an electrically-conductive porous substrate with an oxide containing at least cobalt, an active material filling step of filling the electrically-conductive porous substrate coated with an oxide with a positive active material comprising nickel hydroxide as a main component, and a hydroxide coating step of coating the surface of the active material with which the electrically-conductive porous substrate is filled with nickel hydroxide and a hydroxide of at least one element selected from the group consisting of Ca, Sr, Sc, Y, Al, Mn and lanthanoids.

Thus, when the surface of the electrically-conductive porous substrate coated with an oxide containing cobalt is filled with a positive active material comprising nickel hydroxide as a main component, and the surface of the positive active material is then coated with nickel hydroxide and a hydroxide of at least one element selected from the group consisting of Ca, Sr, Sc, Y, Al, Mn and lanthanoids, a nickel electrode for alkaline storage battery having the electrically-conductive porous substrate coated with an oxide containing at least cobalt on the surface thereof and the positive active material coated with nickel hydroxide and a hydroxide of at least one element selected from the group consisting of Ca, Sr, Sc, Y, Al, Mn and lanthanoids can be easily obtained.

In the process for the production of a nickel electrode for alkaline storage battery of the invention, the cobalt coating step preferably comprises a first dipping step of dipping the electrically-conductive porous substrate in an impregnating solution comprising a salt solution containing at least cobalt, a first alkaline treatment step of dipping the electrically-conductive porous substrate which has been dipped in an impregnating solution in an alkaline solution to form a hydroxide layer containing at least cobalt on the surface of the electrically-conductive porous substrate, and an alkaline heat treatment step of subjecting the oxide containing at least cobalt on the surface of electrically-conductive porous substrate to heat treatment in the presence of an alkaline aqueous solution and oxygen to convert the hydoroxide to a higher order cobalt oxide.

In this case, since the higher cobalt oxide obtained at an alkaline heat treatment step exhibits an excellent electrical conductivity, the electrical conductivity of the gap between the electrically-conductive porous substrate and the positive active material can be further improved, making it possible to inhibit further the deterioration of large current charge properties and large current discharge properties. At the first alkaline treatment step, an aqueous solution of at least one alkali selected from the group consisting of LiOH, NaOH, KOH, RbOH and CsOH is preferably used.

Further, the hydroxide coating step preferably comprises a second dipping step of dipping the electrically-conductive porous substrate filled with a positive active material in a mixture of a nickel salt solution and a solution of salt of at least one element selected from the group consisting of Ca, Sr, Sc, Y, Al, Mn and lanthanoids, and a second alkaline treatment step of dipping the electrically-conductive porous substrate which has been dipped in a mixture of salt solutions in an alkaline solution to form nickel hydroxide and a hydroxide of at least one element selected from the group consisting of Ca, Sr, Sc, Y, Al, Mn and lanthanoids on the surface of the active material.

### DETAILED DESCRIPTION OF THE PREFERRED EMBODIMNETS

1. Preparation of Sintered Substrate

A nickel powder was kneaded with a thickening agent such as carboxymethyl cellulose and water to prepare a slurry which was then coated onto an electrically-conductive core made of punching metal. Thereafter, the electrically-conductive core onto which the slurry had been coated was sintered in a reducing atmosphere to prepare a nickel sintered substrate having a porosity of about 80% (electrically-conductive porous substrate). The nickel sintered substrate thus obtained was referred to as “electrically-conductive porous substrate α”. Subsequently, the electrically-conductive porous substrate α was dipped in a cobalt nitrate solution having a concentration of 1 mol/1 to fill the pores in the electrically-conductive porous substrate α with cobalt nitrate.

Thereafter, the electrically-conductive porous substrate α was dipped in an aqueous solution of sodium hydroxide having a concentration of 6 mol/l and a temperature of 60° C. so that cobalt nitrate was chemically changed to cobalt hydroxide. The electrically-conductive porous substrate α was subjected to heat treatment at a temperature of 150° C. in air without being washed with water and hence with the alkaline content left unremoved (This treatment is referred to as “alkaline treatment”) for 120 minutes. In this manner, cobalt hydroxide was converted to higher order cobalt oxide so that a coat layer of higher order cobalt oxide was formed on the surface of the electrically-conductive porous substrate a. Subsequently, this substrate was washed with water, and then dried to prepare a substrate having a coat layer of higher order cobalt oxide formed on the surface of the electrically-conductive porous substrate α. This substrate was referred to as “electrically-conductive porous substrate β”.

2. Preparation of Nickel Electrode

### (1) EXAMPLE

The cobalt-coated electrically-conductive porous substrate β thus prepared was dipped in an aqueous solution of nickel nitrate having a specific gravity of 1.70, and then dried. Subsequently, the substrate was dipped in an aqueous solution of sodium hydroxide having a density of 6 mol/l and a temperature of 60° C. so that it was subjected to alkaline treatment to cause nickel nitrate to be chemically changed to nickel hydroxide as an active material. Thereafter, this substrate was washed with water, and then dried. This operation of filling with an active material was repeatedly effected five times to obtain an active material-filled electrode having the pores in the cobalt-coated electrically-conductive porous substrate filled with an active material comprising nickel hydroxide as a main component in a predetermined amount.

Subsequently, the active material-filled electrode thus obtained was dipped in a mixed solution of nickel nitrate and yttrium nitrate having a specific gravity of 1.4 (aqueous solution prepared such that the nitrate molar ratio of nickel nitrate and yttrium nitrate is 50:50). Subsequently, the electrode was dipped in an aqueous solution of sodium hydroxide having a concentration of 7 mol/l and a temperature of 60° C. so that it was subjected to alkaline treatment to cause nickel hydroxide and yttrium hydroxide to be deposited on the surface of the active material. In this manner, an electrode having the pores in the cobalt-coated electrically-conductive porous substrate β on which a coat layer of higher cobalt oxide had been formed filled with an active material comprising nickel hydroxide as a main component and a coat layer of nickel hydroxide and yttrium hydroxide formed on the surface of the active material was obtained. The electrode thus obtained was then cut into a predetermined size to obtain a nickel electrode a of the present example.

### (2) Comparative Example 1

The electrically-conductive porous substrate α prepared as mentioned above was dipped in an aqueous solution of nickel nitrate having a specific gravity of 1.70, and then dried. Subsequently, the substrate was dipped in an aqueous solution of sodium hydroxide having a density of 6 mol/l and a temperature of 60° C. so that it was subjected to alkaline treatment to cause nickel nitrate to be chemically changed to nickel hydroxide as an active material. Thereafter, this substrate was washed with water, and then dried. This operation of filling with an active material was repeatedly effected five times to obtain an active material-filled electrode having the pores in the cobalt-coated electrically-conductive porous substrate α filled with an active material comprising nickel hydroxide as a main component in a predetermined amount. The electrode thus obtained was then cut into a predetermined size to obtain a nickel electrode b of Comparative Example 1.

### (3) Comparative Example 2

The cobalt-coated electrically-conductive porous substrate β prepared as mentioned above was dipped in an aqueous solution of nickel nitrate having a specific gravity of 1.70, and then dried. Subsequently, the substrate was dipped in an aqueous solution of sodium hydroxide having a density of 6 mol/l and a temperature of 60° C. so that it was subjected to alkaline treatment to cause nickel nitrate to be chemically changed to nickel hydroxide as an active material. Thereafter, this substrate was washed with water, and then dried. This operation of filling with an active material was repeatedly effected five times to obtain an active material-filled electrode having the pores in the cobalt-coated electrically-conductive porous substrate β filled with an active material comprising nickel hydroxide as a main component in a predetermined amount. The electrode thus obtained was then cut into a predetermined size to obtain a nickel electrode c of Comparative Example 2.

### (4) Comparative Example 3

The active material-filled electrode α prepared as mentioned above was dipped in a mixed solution of nickel nitrate and yttrium nitrate having a specific gravity of 1.70 (aqueous solution prepared such that the nitrate molar ratio of nickel nitrate and yttrium nitrate is 99:1), and then dried. Subsequently, the substrate was dipped in an aqueous solution of sodium hydroxide having a density of 6 mol/l and a temperature of 60° C. so that it was subjected to alkaline treatment to cause nickel nitrate to be chemically changed to nickel hydroxide as an active material. Thereafter, this substrate was washed with water, and then dried. This operation of filling with an active material was repeatedly effected five times to obtain an active material-filled electrode having the pores in the cobalt-coated electrically-conductive porous substrate α filled with an active material comprising nickel hydroxide as a main component in a predetermined amount. The electrode thus obtained was then cut into a predetermined size to obtain a nickel electrode d of Comparative Example 3.

### (5) Comparative Example 4

The electrically-conductive porous substrate α prepared as mentioned above was dipped in an aqueous solution of nickel nitrate having a specific gravity of 1.70, and then dried. Subsequently, the substrate was dipped in an aqueous solution of sodium hydroxide having a density of 6 mol/l and a temperature of 60° C. so that it was subjected to alkaline treatment to cause nickel nitrate to be chemically changed to nickel hydroxide as an active material. Thereafter, this substrate was washed with water, and then dried. This operation of filling with an active material was repeatedly effected five times to obtain an active material-filled electrode having the pores in the electrically-conductive porous substrate α filled with an active material comprising nickel hydroxide as a main component in a predetermined amount.

Subsequently, the active material-filled electrode thus obtained was dipped in a mixed solution of nickel nitrate and yttrium nitrate having a specific gravity of 1.4 (aqueous solution prepared such that the nitrate molar ratio of nickel nitrate and yttrium nitrate is 50:50). Subsequently, the electrode was dipped in an aqueous solution of sodium hydroxide having a concentration of 7 mol/l and a temperature of 60° C. so that it was subjected to alkaline treatment to cause nickel hydroxide and yttrium hydroxide to be deposited on the surface of the active material. In this manner, an electrode having the pores in the cobalt-coated electrically-conductive porous substrate a filled with an active material comprising nickel hydroxide as a main component and a coat layer of nickel hydroxide and yttrium hydroxide formed on the surface of the active material was obtained. The electrode thus obtained was then cut into a predetermined size to obtain a nickel electrode e of Comparative Example 4.

### (6) Comparative Example 5

The cobalt-coated electrically-conductive porous substrate β prepared as mentioned above was dipped in an aqueous solution of nickel nitrate having a specific gravity of 1.70, and then dried. Subsequently, the substrate was dipped in an aqueous solution of sodium hydroxide having a density of 6 mol/l and a temperature of 60° C. so that it was subjected to alkaline treatment to cause nickel nitrate to be chemically changed to nickel hydroxide as an active material. Thereafter, this substrate was washed with water, and then dried. This operation of filling with an active material was repeatedly effected five times to obtain an active material-filled electrode having the pores in the cobalt-coated electrically-conductive porous substrate β filled with an active material comprising nickel hydroxide as a main component in a predetermined amount.

Subsequently, the active material-filled electrode thus obtained was dipped in an aqueous solution of yttrium nitrate having a specific gravity of 1.4. Subsequently, the electrode was dipped in an aqueous solution of sodium hydroxide having a concentration of 7 mol/l and a temperature of 60° C. so that it was subjected to alkaline treatment to cause yttrium hydroxide to be deposited on the surface of the active material. In this manner, an electrode having the pores in the cobalt-coated electrically-conductive porous substrate filled β with an active material comprising nickel hydroxide as a main component and a coat layer of yttrium hydroxide formed on the surface of the active material was obtained. The electrode thus obtained was then cut into a predetermined size to obtain a nickel electrode f of Comparative Example 5.

3. Preparation of Nickel-Cadmium Storage Battery

Subsequently, these nickel electrodes a to f were each combined with a known cadmium electrode and a polypropylene separator to form the respective electrode. Thereafter, these electrodes were each inserted in an outer case. Into the outer case was then injected an aqueous solution of potassium hydroxide (KOH) having a density of 8 mol/l to prepare SC-size nickel-cadmium storage batteries A to F having a rated capacity of 1,200 mAh. In some detail, the nickel-cadmium storage battery comprising the nickel electrode a was referred to as “battery A”, the nickel-cadmium storage battery comprising the nickel electrode b was referred to as “battery B”, the nickel-cadmium storage battery comprising the nickel electrode c was referred to as “battery C”, the nickel-cadmium storage battery comprising the nickel electrode d was referred to as “battery D”, the nickel-cadmium storage battery comprising the nickel electrode e was referred to as “battery E”, and the nickel-cadmium storage battery comprising the nickel electrode f was referred to as “battery F”.

4. Measurement of Battery Performance

(1) Measurement of Intermediate Discharge Voltage

These batteries A to F were each charged with a charging current of 120 mA (0.1 It: It is a value represented by rated capacity (Ah)/1h (time)) at ordinary temperature (25° C.) for 16 hours. Thereafter, these batteries were each discharged with a discharging current of 1,200 mA (1 It) at ordinary temperature (25° C.) until the battery voltage reached 1.0 V. From the discharge time was then determined the discharge capacity after ordinary temperature charge at 0.1 It (1 It discharge capacity). The results are set forth in Table 1 below. Further, the discharge intermediate voltage (battery voltage developed when half the period of time between the initiation of discharge and the time at which the battery voltage reaches 1.0 V elapses) was determined. The results are set forth in Table 1 below.

(2) Measurement of High Temperature Charge Properties

These batteries A to F were each also charged with a discharge current of 120 mA (0.1 It) at a high temperature (45° C.) for 16 hours. Thereafter, these batteries were each discharged with 1,200 mA (1 It) at ordinary temperature (25° C.) until the battery voltage reached 1.0 V. From the discharge time was then determined the discharge capacity after high temperature (45° C.) discharge. Subsequently, the ratio of the discharge capacity after ordinary charge which had been previously determined at the step (1) to the discharge capacity after high temperature charge was determined as high temperature charge properties according to the following equation (1). The results are set forth in Table 1 below.

High temperature charge properties (%)=(discharge capacity after high temperature charge/discharge capacity after ordinary temperature charge)×100% (1)

(3) Measurement of Rapid Charge Properties

These batteries A to F were each also charged with a charge current of 1,200 mA (1 It) at ordinary temperature (25° C.) for 1.5 hours. Thereafter, these batteries were each discharged with a discharge current of 1,200 mA (1 It) at ordinary temperature (25° C.) until the battery voltage reached 1.0 V. From the discharge time was then determined the discharge capacity after 1 It rapid discharge. Subsequently, the ratio of the discharge capacity after 0.1 It charge which had been previously determined at the step (1) to the discharge capacity after 1 It charge was determined as rapid charge properties according to the following equation (2). The results are set forth in Table 1 below.

Rapid charge properties (%)=(discharge capacity after 1 It charge/discharge capacity after 0.1 It charge)×100% (2)

(4) Measurement of High Rate Discharge Properties

These batteries A to F were each also charged with a charge current of 120 mA (0.1 It) at ordinary temperature (25° C.) for 16 hours. Thereafter, these batteries were each discharged with a discharge current of 12,000 mA (10 It) at ordinary temperature (25° C.) until the battery voltage reached 1.0 V. From the discharge time was then determined the 10 It high rate discharge capacity. Subsequently, the ratio of the 1 It discharge capacity which had been previously determined at the step (1) to the 10 It high rate discharge capacity was determined as high rate discharge properties (large current discharge properties) according to the following equation (3). The results are set forth in Table 1 below.

High rate discharge properties (%)=(10 It high rate discharge capacity/1 It discharge capacity)×100% (3)

TABLE 1

| | | | | Discharge | % High | | |
|---|---|---|---|---|---|---|---|
| | Coated | | | inter-mediate | temperature | % Rapid | % High rate |
| Kind of | with Co | Addition of Y, Ni + Y | | voltage | charge | charge | discharge |
| battery | oxide ? | Added ? | Adding method | (V) | properties | properties | properties |
| A | Yes | Yes | Added to surface | 1.213 | 92(116) | 95(101) | 78(101) |
| | | | (Ni + Y) | | | | |
| B | No | No | — | 1.216 | 79(100) | 94(100) | 77(100) |
| C | Yes | No | — | 1.214 | 80(101) | 97(103) | 81(105) |
| D | No | Yes | Solid solution | 1.213 | 82(104) | 90(96) | 72(94) |
| E | No | Yes | Added to surface | 1.210 | 90(114) | 89(95) | 70(91) |
| | | | (Ni + Y) | | | | |
| F | Yes | Yes | Added to surface | 1.209 | 92(116) | 93(99) | 76(99) |
| | | | (Y) | | | | |

In the high temperature charge properties, rapid charge properties and high discharge properties set forth in Table 1, the figure in the parenthesis indicates the ratio (%) of the value relative to that of the battery B as 100.

As can be seen in the results set forth in Table 1, the battery C comprising the nickel electrode c having the cobalt-coated electrically-conductive porous substrate β coated with a higher cobalt oxide on a sintered substrate filled with an active material exhibits improved high temperature charge properties, rapid charge properties and high rate discharge properties as compared with the battery B comprising the nickel electrode b having the cobalt-uncoated electrically-conductive porous substrate α filled with an active material. While the cobalt oxide in the cobalt-coated electrically-conductive porous substrate β is a higher cobalt oxide, an electrically-conductive porous substrate coated with a cobalt oxide which is not a higher cobalt oxide may be used.

It can also be seen that the batteries A, D, E and F comprising the nickel electrodes a, d, e and f having yttrium (Y) incorporated therein, respectively, exhibit improved high temperature charge properties as compared with the batteries B and C comprising the yttrium-free nickel electrodes b and c, respectively. Further, the batteries A, E and F comprising the nickel electrodes a, e and f, respectively, having yttrium incorporated therein but only in the surface of the active material exhibit improved high temperature charge properties as compared with the battery D comprising the nickel electrode d having yttrium solid-dissolved therein. This means that yttrium is preferably incorporated in the surface of an active material to improve high temperature charge properties.

On the other hand, the batteries D and E comprising the nickel electrodes d and e, respectively, having yttrium (Y) incorporated therein exhibit deteriorated rapid charge properties and high rate discharge properties as compared with the batteries B and C comprising the yttrium-free nickel electrodes d and c, respectively. Moreover, although it not shown in the embodiment, the battery E exhibits the deteriorated rapid charge property and high rate discharge property as compared with an example that has substantial equivalent components but dose not include Ni. However, it can be seen that the battery F comprising the nickel electrode f having the cobalt-coated electrically-conductive porous substrate β having a sintered substrate coated with a higher cobalt oxide on the surface thereof exhibits almost the same level of discharge intermediate voltage (operating voltage), rapid charge properties and high rate discharge properties as that of the battery B comprising the nickel electrode b having the yttrium-free and cobalt oxide layer-free electrically-conductive porous substrate α filled with an active material.

This means that the formation of a cobalt oxide layer on the surface of a sintered substrate makes it possible to inhibit the deterioration of discharge intermediate voltage (operating voltage), rapid charge properties and high rate discharge properties. It can also be seen that the battery A comprising the nickel electrode a having nickel (Ni) and yttrium (Y) incorporated in the surface of an active material exhibits improved discharge intermediate voltage (operating voltage), rapid charge properties and high rate discharge properties as compared with the battery F comprising the nickel f having only yttrium (Y) incorporated in the surface of an active material.

As mentioned in detail above, in the invention, the use of a sintered substrate coated with a cobalt (Co) oxide layer on the surface thereof and a nickel electrode having a coat layer of nickel and yttrium provided on the surface of an active material makes it possible to obtain an alkaline storage battery which exhibits excellent high temperature charge properties and can inhibit the deterioration of discharge intermediate voltage (operating voltage), rapid charge properties and high rate discharge properties at ordinary temperature.

While the aforementioned embodiment has been described with reference to the case where as the impregnating solution for coating the surface of an active material with yttrium there is used a yttrium nitrate solution, similar effects can be exerted also by using a nitrate solution containing Ca, Sr, Sc, Al, Mn or lanthanoids instead of the yttrium nitrate solution to provide a coat layer of Ca, Sr, Sc, Al, Mn or lanthanoids on the surface of an active material.

While the aforementioned embodiment has also been described with reference to the case where the surface of an electrically-conductive porous substrate is coated with only a cobalt oxide, similar effects can be exerted also by coating the surface of the electrically-conductive porous substrate with a mixture of cobalt oxide and nickel oxide instead of the cobalt oxide coat.

What is claimed is:

1. A nickel electrode for alkaline storage battery comprising an electrically-conductive porous substrate filled with a positive active material comprising nickel hydroxide as a main component,
wherein the surface of the electrically-conductive porous substrate is coated by an oxide containing at least cobalt and
the surface of the positive active material comprising nickel hydroxide as a main component is coated by nickel hydroxide and a hydroxide of at least one element selected from the group consisting of Ca, Sr, Sc, Y, Al, Mn and lanthanoids.

2. The nickel electrode for alkaline storage battery as defined in claim 1, wherein the oxide containing cobalt is a higher order cobalt oxide obtained by subjecting cobalt hydroxide or a hydroxide having solid solution of cobalt to heat treatment in the presence of oxygen and an alkali.

3. A process for the production of a nickel electrode for alkaline storage battery which comprises filling an electrically-conductive porous substrate with a positive active material comprising nickel hydroxide as a main component, comprising:
a cobalt coating step of coating the surface of the electrically-conductive porous substrate with an oxide containing at least cobalt;
an active material filling step of filling the electrically-conductive porous substrate which surface is coated with the oxide containing at least cobalt with the positive active material comprising nickel hydoroxide as the main component; and
a hydroxide coating step of coating the surface of the active material with which the electrically-conductive porous substrate is filled with nickel hydroxide and a hydroxide of at least one element selected from the group consisting of Ca, Sr, Sc, Y, Al, Mn and lanthanoids.

4. The process for the production of a nickel electrode for alkaline storage battery as defined in claim 3, wherein the cobalt coating step comprises:
a first dipping step of dipping the electrically-conductive porous substrate in a salt solution containing at least cobalt;
a first alkaline treatment step of dipping the electrically-conductive porous substrate which has been dipped in a salt solution in an alkaline solution to form a hydoroxide containing at least cobalt on the surface of the electrically-conductive porous substrate; and
an alkaline heat treatment step of subjecting the oxide containing at least cobalt on the surface of electrically-conductive porous substrate to heat treatment in the presence of an alkaline aqueous solution and oxygen to convert the hydoroxide to a higher order cobalt oxide.

5. The process for the production of a nickel electrode for alkaline storage battery as described in claim 4, wherein the first alkaline treatment step involves the use of an aqueous solution of at least one alkali selected from the group consisting of LiOH, NaOH, KOH, RbOH and CsOH.

6. The process for the production of a nickel electrode for alkaline storage battery as defined in claim 3, wherein the hydroxide coating step comprises:
a second dipping step of dipping the electrically-conductive porous substrate filled with a positive active material in a mixture of a nickel salt solution and a solution of salt of at least one element selected from the group consisting of Ca, Sr, Sc, Y, Al, Mn and lanthanoids; and
a second alkaline treatment step of dipping the electrically-conductive porous substrate which has been dipped in a mixture of salt solutions in an alkaline solution to form nickel hydroxide and a hydroxide of at least one element selected from the group consisting of Ca, Sr, Sc, Y, Al, Mn and lanthanoids on the surface of the active material.

7. An alkaline storage battery comprising a nickel positive electrode, a negative electrode, a separator for separating the positive electrode and the negative electrode from each other and an alkaline electrolyte provided in an outer case, wherein the nickel positive electrode is a nickel electrode as defined in claim 1 or 2.

8. A process for the production of an alkaline storage battery which comprises receiving a nickel positive electrode prepared through a positive electrode producing step and a negative electrode prepared through a negative electrode producing step opposed to each other with a separator interposed therebetween together with an alkaline electrolyte in an outer case, wherein the positive electrode producing step involves a process for the production of a nickel electrode as defined in any one of claims 3 to 6.
